(19) United States
(12) Patent Application Publication
(10) Pub. No.: US 2011/0154676 A1
(43) Pub. Date: Jun. 30, 2011

(54) Home Laundry Drier with Releasably Securable Vibration Damper

(75) Inventors: Massimo CASTIGLIONE, Porcia (IT); Paolo ROS, Porcia (IT)

(73) Assignee: ELECTROLUX HOME PRODUCTS CORPORATION N.V., Zaventem (BE)

(21) Appl. No.: 12/979,819

(22) Filed: Dec. 28, 2010

(30) Foreign Application Priority Data
Dec. 29, 2009 (EP) 09180836.0

(51) Int. Cl. F26B 21/00; F25B 27/02

(52) U.S. Cl. 34/86; 62/238.6

(57) ABSTRACT

A home laundry drier (1) is provided with a heat-pump assembly (11) having a refrigerant compressing device (15) which is connected to a supporting wall (2b) of the casing (2) via one or more vibration dampers (17) structured for floatingly supporting the refrigerant compressing device (15). At least one of the vibration dampers (17) includes an elastically-deformable hollow body (18), and a central retaining rod (20) which extends through the elastically-deformable hollow body (18). The central retaining rod (20) is axially displaceable between a locking position in which a head portion (20b) of the rod (20) compresses the elastically-deformable hollow body (18) so as to rigidly connect the compressor (15) to the supporting wall (2b) of the casing (2) and a unlocking position in which the elastically-deformable hollow body (18) floatingly supports the refrigerant compressing device (15). An end portion (20c) of the central retaining rod (20) is accessible from outside of the outer casing (2) so as to allow a user to displace the central retaining rod (20).

### CROSS-REFERENCE TO RELATED APPLICATION

This application claims priority under 35 U.S.C. §119 to European application EP 09180836.0, filed Dec. 29, 2009.

### BACKGROUND OF THE INVENTION

The present invention relates to a home laundry drier. More specifically, the present invention relates to a rotary-drum, heat-pump type, home laundry drier, to which the following description refers purely by way of example.

As is known, present rotary-drum home laundry driers generally comprise a substantially parallelepiped-shaped outer box casing; a cylindrical bell-shaped drum for housing the laundry to be dried, and which is housed in axially rotating manner inside the casing to rotate about its horizontally oriented longitudinal axis, directly facing a laundry loading/unloading opening formed in the front face of the casing; a door hinged to the front face of the casing to rotate to and from a closing position in which the door rests completely against the casing to close the opening in the front face of the casing and seal the revolving drum; and an electric motor assembly for rotating the drum about its longitudinal axis inside the casing.

Rotary-drum home laundry driers of the above type are also provided with a closed-circuit, hot-air generator which is designed to circulate inside the revolving drum a stream of hot air with a low moisture content, and which flows through the revolving drum and over the laundry inside the drum to rapidly dry the laundry.

In the heat-pump type, home laundry driers, the closed-circuit, hot-air generator comprises an air recirculating conduit having its two ends connected to the revolving drum, on opposite sides of the latter; an electric centrifugal fan located along the recirculating conduit to produce, inside the latter, an airflow which flows through the revolving drum; and finally a heat-pump assembly having its two heat exchangers located one after the other, along the air recirculating conduit.

More specifically, the heat-pump assembly comprises a first air/refrigerant heat exchanger which provides for rapidly cooling the airflow arriving from the revolving drum to condense and restrain the surplus moisture in the airflow; a second air/refrigerant heat exchanger which provides for rapidly heating the airflow arriving from the first heat exchanger and directed back to the revolving drum, so that the airflow re-entering into the revolving drum is heated rapidly to a temperature higher than or equal to that of the air flowing out of the revolving drum; and an electric refrigerant compressing device which is interposed between the outlet of the first heat exchanger and the inlet of the second heat exchanger, and which compresses the gaseous refrigerant directed towards the second heat exchanger so that refrigerant pressure and temperature are much higher at the inlet of the second heat exchanger than at the outlet of the first heat exchanger.

Finally, the heat-pump assembly is provided with a refrigerant expansion device which is interposed between the outlet of the second heat exchanger and the inlet of the first heat exchanger, and is structured so as to cause a rapid expansion of the refrigerant directed towards the first heat exchanger so that refrigerant pressure and temperature are much higher at the outlet of the second heat exchanger than at the inlet of the first heat exchanger.

To reduce appliance noise and vibrations, in today's home laundry driers the electric refrigerant compressing device is anchored to the appliance casing via a number of vibration dampers structured for floatingly supporting the refrigerant compressing device at a given distance from the bottom of the appliance casing.

More specifically, each leg of the electric refrigerant compressing device is attached to the bottom of the appliance casing via a respective vibration damper generally consisting in a cylindrical elastomeric pad of given height which is firmly anchored to the bottom of the casing via a central through bolt. The leg of the electric refrigerant compressing device is firmly mortised/fitted onto the periphery of the elastomeric pad, close to the top end of the latter and spaced from the central bolt, so that the elastically deformable body of the pad prevents mechanical vibrations from reaching the bottom of the appliance casing.

Since the floating connection between the electric refrigerant compressing device and the appliance casing may cause, during appliance transportation, serious damages to the refrigerant compressing device, today's home laundry driers are also provided with one or more manually-removable retaining screws each of which extends vertically through a corresponding leg of the electric refrigerant compressing device, beside the vibration damper, and is screwed directly into the bottom of the appliance casing, so as to rigidly connect the electric refrigerant compressing device to the bottom of the appliance casing. The user is requested to manually remove all retaining screws before first use of the drier.

Despite being very efficient and relatively inexpensive, the use of the retaining screws requires the user to access the inside of the appliance casing, before the first use of the laundry drier, for completely removing all retaining screws on the refrigerant compressing device to restore the floating connection between the refrigerant compressing device and the appliance casing, with all problems involved in that operation. In fact, during this compulsory access to the inside of the home laundry drier, the user may unintentionally damage any internal component part of the home laundry drier.

### SUMMARY OF SELECTED INVENTIVE ASPECTS

An aim of the present invention is therefore to provide a home laundry drier featuring a more user-friendly and safety system for temporarily fixing in a rigid and stable, but easy releasable manner, the legs of the electric refrigerant compressing device to the bottom of the appliance casing. In compliance with the above aims, according to the present invention there is provided a home laundry drier as set forth in the claims.

### BRIEF DESCRIPTION OF THE DRAWINGS

A non-limiting embodiment of the present invention will now be described, by way of example, with reference to the accompanying drawings, in which:

FIG. 1 shows a section view, with parts removed for clarity, of a rotary-drum home laundry drier realized in accordance with the teachings of the present invention;

FIG. 2 shows an enlarged view, with parts in section and parts removed for clarity, of the bottom portion of the FIG. 1 home laundry drier; and

FIG. 3 shown a section view of one of the vibration dampers supporting the rotary-drum home laundry drier, as shown in FIGS. 1 and 2.

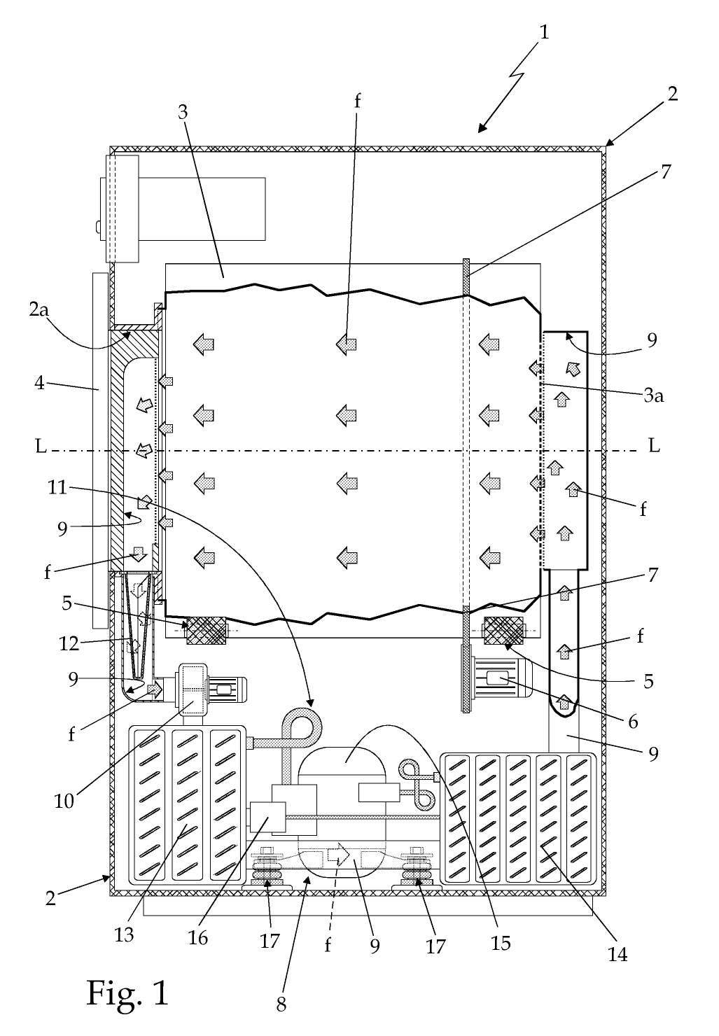

With reference to FIG. 1, number 1 indicates as a whole a home laundry drier which comprises: a preferably, though not necessarily, parallelepiped-shaped outer box casing 2; a preferably, though not necessarily, cylindrical, bell-shaped revolving drum 3 for housing the laundry to be dried, and which is fixed in axially rotating manner inside casing 2, directly facing a laundry loading/unloading opening 2a formed in the front face of casing 2; and a door 4 hinged to the front face of casing 2 to rotate to and from a closing position in which door 4 rests completely against the front face of casing 2 to close opening 2a and seal revolving drum 3.

More specifically, in the example shown, revolving drum 3 rests horizontally inside casing 2 on a number of horizontal supporting rollers 5 which are fitted to casing 2 in free revolving manner to let revolving drum 3 freely rotate about its longitudinal axis L.

Casing 2, revolving drum 3, door 4 and supporting rollers 5 are commonly known parts in the industry, and therefore not described in detail.

With reference to FIG. 1, inside casing 2 laundry drier 1 also comprises an electric motor 6 which is mechanically coupled to revolving drum 3 preferably, though not necessarily, via a driving belt 7 for rotating, on command, revolving drum 3 about its longitudinal axis L inside casing 2; and a closed-circuit, hot-air generator 8 designed to circulate through revolving drum 3, on command, a stream of hot air having a low moisture level, and which flows over and rapidly dries the laundry inside drum 3.

More specifically, closed-circuit, hot-air generator 8 provides for gradually drawing air from revolving drum 3; extracting and retaining the surplus moisture from the hot air drawn from revolving drum 3; heating the dehumidified air to a predetermined temperature, normally higher than the temperature of the air from revolving drum 3; and feeding the heated, dehumidified air back into revolving drum 3, where it flows over, to rapidly dry, the laundry inside the drum.

In other words, hot-air generator 8 provides for continually dehumidifying and heating the air circulating inside revolving drum 3 to rapidly dry the laundry inside the drum, and substantially comprises:
an air recirculating conduit 9, the two ends of which are connected to revolving drum 3 on opposite sides of the latter;
an electric centrifugal fan 10 or other type of air circulating pump, located along recirculating conduit 9 to produce, inside recirculating conduit 9, an airflow f which flows through revolving drum 3 and over the laundry inside drum 3; and
a heat-pump assembly 11 which is able to rapidly cool the airflow f coming out from revolving drum 3 for condensing and retaining the surplus moisture in the airflow f, and then to rapidly heat the airflow f returning back into revolving drum 3, so that the airflow entering into revolving drum 3 is heated rapidly to a temperature higher than or equal to that of the same air flowing coming out of the drum.

With reference to FIG. 1, in the example shown, the back wall 3a of revolving drum 3 is perforated, or at any rate permeable to air, to permit air entry into drum 3, and the exhaust end of recirculating conduit 9 is coupled in airtight manner directly to the back wall 3a of revolving drum 3; whereas the intake end of recirculating conduit 9 can be integrated into door 4, and is faced to the front opening of revolving drum 3 when door 4 is placed in the closing position.

Centrifugal fan 10, instead, is designed to produce an airflow f which flows, along recirculating conduit 9, from the intake end of recirculating conduit 9 to the exhaust end of recirculating conduit 9.

With reference to FIG. 1, preferably, though not necessarily, hot-air generator 8 is also provided with a manually-removable filtering device 12 which is located along air recirculating conduit 9, upstream of the heat-pump assembly 11 and preferably also of centrifugal fan 10, and is structured to stop fluff and/or lint particles upstream of heat-pump assembly 11 or even centrifugal fan 10.

As regards heat-pump assembly 11, it operates in the same way as a traditional heat-pump apparatus—which is capable of transferring heat from one fluid to another using an intermediate gaseous refrigerant subjected to a closed thermodynamic cycle, the thermodynamic principles of which are widely known and therefore not described in detail—and comprises:
a first air/refrigerant heat exchanger 13 which provides for rapidly cooling the airflow f arriving from revolving drum 3 to condense and restrain the surplus moisture in the airflow f;
a second air/refrigerant heat exchanger 14 which provides for rapidly heating the airflow f arriving from heat exchanger 13 and directed back to revolving drum 3, so that the airflow f re-entering into revolving drum 3 is heated rapidly to a temperature higher than or equal to that of the air flowing out of revolving drum 3;
an electric refrigerant compressing device 15 which is interposed between the outlet of heat exchanger 13 and the inlet of heat exchanger 14, and which compresses the gaseous refrigerant directed towards heat exchanger 14 so that refrigerant pressure and temperature are much higher at the inlet of the second heat exchanger 14 than at the outlet of the first heat exchanger 13; and
an expansion valve 16 or similar refrigerant expansion device (for example an expansion coil) which is interposed between the outlet of heat exchanger 14 and the inlet of heat exchanger 13, and is structured so as to cause a rapid expansion of the refrigerant directed towards the first heat exchanger 13, so that refrigerant pressure and temperature are much higher at the outlet of the second heat exchanger 14 than at the inlet of the first heat exchanger 13.

More specifically, with reference to FIG. 1, the first air/refrigerant heat exchanger 13 is located along recirculating conduit 9—preferably, thought not necessarily, downstream of centrifugal fan 10—and is designed so that the airflow f arriving from revolving drum 3 and the refrigerant flowing to the inlet/suction of compressing device 15 flow through it simultaneously, allowing the refrigerant having a temperature lower than that of the airflow f, to absorb heat from the airflow f thus causing condensation of the surplus moisture in the airflow f.

The second air/refrigerant heat exchanger 14, instead, is located along recirculating conduit 9, downstream of heat exchanger 13, and is designed so that the airflow f directed to revolving drum 3 and the refrigerant arriving from the outlet/delivery of compressing device 15 flow through it simultaneously, allowing the refrigerant having a temperature greater than that of the airflow f to release heat to the airflow f, thus rapidly heating the airflow f to a temperature higher than that of the airflow f coming out of heat exchanger 13, and preferably, thought not necessarily, also higher or equal to the temperature of the airflow f coming out of revolving drum 3.

The electric refrigerant compressing device 15 is structured for continuously compressing, on command, the refrigerant coming out of heat exchanger 13—preferably, though not necessarily, subjecting said refrigerant to a roughly adiabatic compression.

The expansion valve 16, instead, is structured for causing a rapid expansion of the refrigerant flowing from the outlet of heat exchanger 14 to the inlet of heat exchanger 13, so that pressure and temperature of the refrigerant entering in heat exchanger 13 are much lower than pressure and temperature of the refrigerant coming out from heat exchanger 14, thus completing the closed thermodynamic cycle in opposition to the compressing device 15.

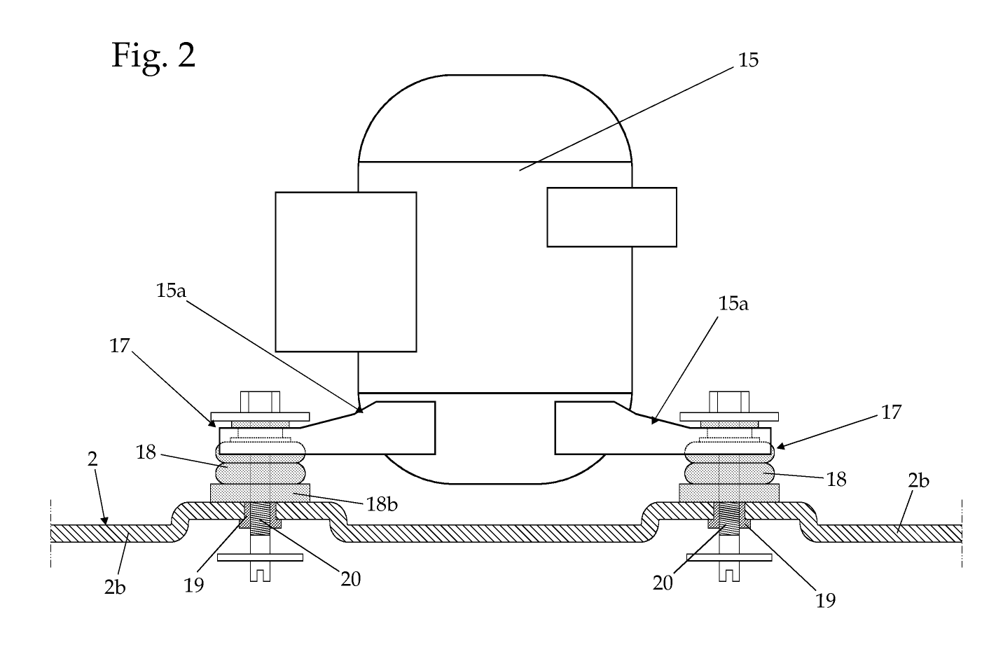

With reference to FIGS. 1 and 2, the refrigerant compressing device 15 is associated/connected to the bottom wall 2b of casing 2 via a number of vibration dampers 17 structured for floatingly supporting the refrigerant compressing device 15 at a given distance from the bottom of the casing, so as to avoid generic transmission of mechanical vibration to casing 2.

More specifically, refrigerant compressing device 15 has a number of outwardly-projecting supporting legs 15a and the distal end of each supporting leg 15a is connected to the bottom wall 2b of casing 2 via a respective vibration damper 17 structured for damping the mechanical vibration generated by refrigerant compressing device 15 when working.

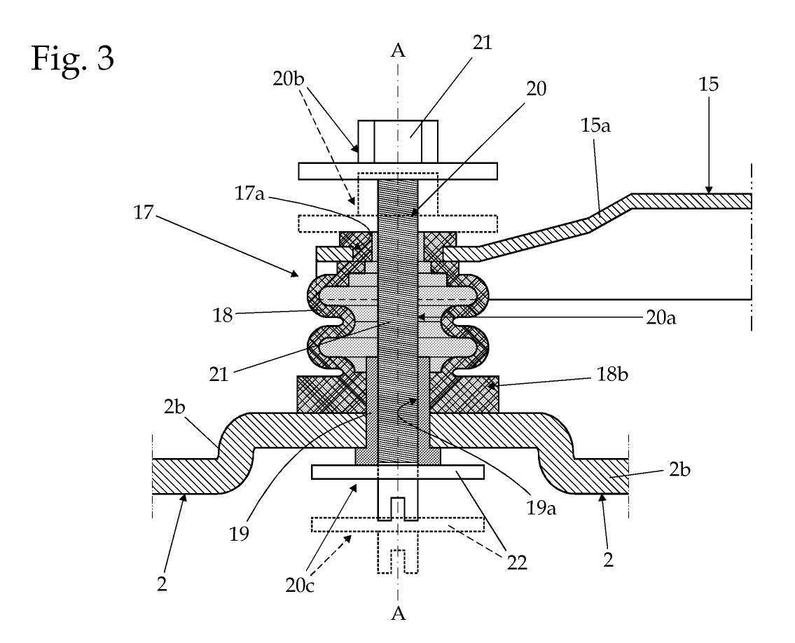

With reference to FIGS. 2 and 3, at least one of said vibration dampers 17 comprises an elastically-deformable hollow body 18 which has a lower base 18b in abutment against the supporting wall 2b of the casing 2, a central retaining rod 20 which extends through the elastically-deformable hollow body 18, the central retaining rod 20 is axially displaceable between a locking position in which a head portion 20b of the rod 20 compresses said elastically-deformable hollow body 18 so as to rigidly connect the compressor 15 to the supporting wall 2b of the casing 2 and a unlocking position in which said elastically-deformable hollow body 18 floatingly supports the compressor 15, an end portion 20a of the central retaining rod 20 being accessible from outside of the outer casing 2 so as to allow a user to displace the central retaining rod 20.

The central retaining rod 20 is coupled to the supporting wall 2b of the casing 2 via a mechanical connection that allows a user to axially displace the central retaining rod 20 at least from the locking position to the unlocking position so as to release the elastically-deformable hollow body 18, which in unlocking position is adapted to floatingly supports the compressor 15. The central retaining rod 20 is displaceable by means of an end portion 20b of the central retaining rod 20 which protrudes from the supporting wall 2b of the casing 2 towards the outside the casing 2 of the dryer.

The mechanical connection that allows a user to axially displace the central retaining rod 20 can be a screw thread coupling, a snap coupling, a spring coupling, a cam mechanism, a releasing mechanism, a bayonet coupling, a rack coupling and other similar and well known couplings and or mechanisms. The user acts on the end portion 20c—accessible from outside of the outer casing 2—of the central retaining rod 20 to operate the mechanical connection so as to displace the central retaining rod 20.

In one embodiment the central retaining rod 20 can be displaced from the locking position to the unlocking position in an irreversible manner by the user before the first operating of the dryer. In that case the central retaining rod 20 is arranged into the locking position during the assembling of the dryer at the manufacturing line.

Preferably, in a further embodiment, the central retaining rod 20 can be displaced from the locking position to the unlocking position in a reversible manner, i.e. even after the first operating of the dryer it is possible to displace the central retaining rod 20 from the unlocking position to the locking position.

Preferably, in a further embodiment, the central retaining rod 20 can be axially displaceable from the locking position to the unlocking position via a clockwise or anticlockwise rotation of the retaining rod 20 about its axis.

Preferably, in a further embodiment, the central retaining rod 20 is axially displaceable by means of a screw thread coupling.

With reference to FIGS. 2 and 3, a preferred non-limiting embodiment of the present invention is described, wherein the mechanical connection provided between the central retaining rod 20 and the supporting wall 2b of the casing 2 to allow the user to axially displace the central retaining rod 20 is a screw thread coupling.

Each vibration damper 17 extends coaxial to a longitudinal reference axis A locally substantially perpendicular to the bottom 2b of casing 2 and comprises: an elastically deformable hollow, cup-shaped body 18 which extends substantially coaxial to axis A and has its lower base 18b in abutment on/against the bottom wall 2b of casing 2; and a central hollow stud or buckle or bushing 19 which extends coaxial to axis A, through the bottom wall 2b of casing 2 and the lower base 18b of cup-shaped body 18, and is force-fitted into, and optionally permanently deformed onto or in a single piece construction with the bottom wall 2b of casing 2.

The distal end of supporting leg 15a is provided with a through hole 17a and the periphery of cup-shaped body 18 is fitted/arranged into the through hole 17a of the supporting leg 15a, close to the upper rim of the cup-shaped body 18 and spaced from central hollow stud 19, so that the elastically deformable, upwards-projecting tubular wall of cup-shaped body 18 can damp the mechanical vibrations traveling along the supporting leg 15a towards the bottom wall 2b of casing 2.

The vibration damper 17 is also provided with a central retaining rod 20 which extends coaxial to axis A, through stud 19, cup-shaped body 18 and the distal end of supporting leg 15a, so that the upper portion of rod 20 juts out of the rim of cup-shaped body 18 and the lower portion of rod 20 juts out of stud 19 outside of casing 2.

Additionally, retaining rod 20 has a cylindrical threaded central section 20a which is partially screwed into the central through hole 19a of stub 19, and is provided with an upper head portion 20b configured for abutting against the upper rim of cup-shaped body 18 so as to compress the elastically deformable hollow body 18, when the retaining rod 20 is in the locking position.

Further, the retaining rod 20 is provided with a lower end portion 20c configured for being accessible outside the casing 2 of the dryer, i.e. configured for protruding from the bottom wall 2b of the casing 2.

Central hole 19a of stub 19, in turn, has a substantially circular cross-section and is internally threaded, so as to allow the manually-controlled axial displacement of retaining rod 20 with respect to stub 19, via a clockwise or anticlockwise rotation of retaining rod 20 about axis A, between:
the locking position (FIG. 2) in which the upper head portion 20b of rod 20 abuts against both the upper rim of cup-shaped body 18, so as to deeply compress and deform the cup-shaped body 18 against the bottom wall 2b of casing 2, for rigidly connecting the supporting leg 15a of the refrigerant compressing device 15 to the bottom wall 2b of casing 2; and
the unlocking position (FIG. 3) in which the upper head portion 20b of rod 20 does not compress the cup-shaped body 18 against the bottom wall 2b of casing 2, thus allowing free floating movement of supporting leg 15a with respect to the bottom wall 2b of casing 2.

More specifically, retaining rod 20 is axially movable between:
the locking position (FIG. 2) in which the upper head portion 20b of rod 20 abuts against both the upper rim of cup-shaped body 18 and the distal end of supporting leg 15a, and the lower end portion 20c of rod 20 is spaced apart from the bottom wall 2b of the casing 2 and the bottom end of central hollow stud 19; and
the unlocking position (FIG. 3) in which the upper head portion 20b of rod 20 is spaced apart from both the upper rim of cup-shaped body 18 and the distal end of supporting leg 15a, and the lower end portion 20c of rod 20 preferably, though not necessarily, is in proximity of the bottom wall 2b of the casing 2 and the bottom end of central hollow stud 19.

With central section 20a of rod 20 permanently screwed into stud 19 and thus rigidly connected to casing 2, when placed in the locking position (FIG. 2), the central retaining rod 20 is able to deeply compress the distal end of supporting leg 15a against the bottom wall 2b of casing 2, temporarily deforming cup-shaped body 18 against the bottom wall 2b of casing 2 so as to rigidly connect the supporting leg 15a of the refrigerant compressing device 15 to the bottom wall 2b of casing 2.

Instead, when placed in the unlocking position (FIG. 3), the central retaining rod 20 does not compress cup-shaped body 18 against the bottom wall 2b of casing 2 and preferably does not touch against cup-shaped body 18, thus allowing free floating movement of supporting leg 15a with respect to the bottom wall 2b of casing 2 and consequent damping of mechanical vibrations in known manner.

With reference to FIGS. 2 and 3, in the example shown, in particular, cup-shaped body 18 is made of elastomeric material, is substantially cylindrical in shape, and optionally has a corrugated lateral wall; whereas central stud or buckle 19 is made of metal material and is substantially cylindrical in shape.

Instead, retaining rod 20 can take the form of a preferably, though not necessarily, hexagonal, flat-headed bolt 21 having an enlarged upper head portion 20b provided at the distal end of the bolt threaded stem and adapted to compress the elastically-deformable hollow body 18.

The enlarged upper head portion 20b of retaining rod 20 can be realized in one piece construction with rod 20, and can comprise the head of bolt 21 or alternatively a washer can be provided so as to define the enlarged portion adapted to compress the elastically-deformable hollow body 18.

The lower end portion 20c of retaining rod 20 can comprises a washer 22, nut, blind-nut, transversal pin or similar stop element, located on the distal end of the threaded stem of bolt 21.

The stop element provides the user with a visual reference so as to easily identify whether the retaining rod 20 is in the locking or unlocking position.

Thus during appliance assembly, it is possible to firstly screw the hexagonal-headed bolt 21 into the central hole 19a of stub 19 until the distal end of the bolt threaded stem sticks out of the bottom end of central hollow stud 19, and then rigidly fit washer 22 or similar stop element onto the distal end of the threaded stem of bolt 21.

Obviously, in a different embodiment, lower end portion 20c of retaining rod 20 may consist of the head of bolt 21, whereas upper head portion 20b of retaining rod 20 is defined by the washer 22, nut or transversal pin, fitted onto the distal end of the threaded stem of bolt 21.

General operation of home laundry drier 1 is clearly inferable from the above description, with no further explanation required.

As regards vibration dampers 17, during appliance assembly retaining rod 20 is placed/screwed in the locking position (FIG. 2) so as to rigidly connect the refrigerant compressing device 15 to casing 2. Before the first use of the appliance, the user is simply requested to tilt the appliance so as to reach the bottom of casing 2 and to manually screw totally into casing 2 the retaining rods 20 that jut out from the bottom of casing 2, acting from outside the appliance casing 2 and using a suitable tool such as a screwdriver, hexagonal key, monkey wrench, Allen wrench or pliers, according to the shape of the lower end portion 20c of retaining rod 20, so as to move each retaining rod 20 from the locking (FIG. 2) to the unlocking position (FIG. 3).

In the example shown, in particular, the tip of the lower end portion 20c of the retaining rod 20 can be provided with a transversal groove suitable to be engaged by the tip of a traditional screwdriver.

The advantages connected to the particular structure of vibration dampers 17 are remarkable. First of all, the user is no more requested to access the inside of the home laundry drier with the risk of unintentionally damaging any internal device. Moreover retaining rods 20 remain in place on the bottom wall 2b of the appliance casing for further possible uses.

Clearly, changes may be made to home laundry drier 1 as described herein without, however, departing from the scope of the present invention. For example, stud or buckle 19 may be replaced by a inwards projecting cylindrical tubular sleeve realized in one piece with the bottom wall 2b of casing 2, and the elastically deformable cup-shaped body 18 may be replaced by an elastically deformable, tubular-shaped body 18 simply fitted onto said tubular sleeve. In this case, the cylindrical threaded central section 20a of retaining rod 20 is screwed into the cylindrical tubular sleeve.

In a simpler embodiment, furthermore, lower end portion 20c of retaining rod 20 may be replaced by a notch or other mark realized onto the external surface of retaining rod 20. More specifically, washer 22 may be replaced by a notch or other mark realized onto the threaded stem of bolt 21, close to the distal end of the stem so as to provide the user with a visual reference for identifying whether the retaining rod 20 is in the locking or unlocking position. In this case, the user is requested to manually screw into casing 2 the retaining rods 20 (i.e. the stem of bolt 21) that jut out from the bottom of casing 2, as far as the notch or other mark on the distal end of the stem disappears inside stud or buckle 19.

1. A laundry drier comprising an outer casing and, inside the casing, a laundry drying container for housing the laundry to be dried, and a hot-air generator for circulating a stream of hot air inside the laundry drying container; said hot-air generator being provided with a heat-pump assembly having a refrigerant compressing device which is connected to a supporting wall of the casing via one or more vibration dampers structured for floatingly supporting the refrigerant compressing device, wherein:
at least one of said vibration dampers comprises an elastically-deformable hollow body which has a lower base in abutment against the supporting wall of the casing, and a central retaining rod which extends through the elastically-deformable hollow body,
the central retaining rod is axially displaceable between a locking position in which a head portion of the rod compresses said elastically-deformable hollow body so as to rigidly connect the compressing device to the supporting wall of the casing and an unlocking position in which said elastically-deformable hollow body floatingly supports the refrigerant compressing device, and
an end portion of the central retaining rod is accessible from outside of the outer casing so as to allow a user to displace the central retaining rod to move it between said locking position and said unlocking position.

2. A laundry drier as claimed in claim 1, wherein the end portion of the rod protrudes from the supporting wall outside of the casing.

3. A laundry drier as claimed claim 1, wherein the end portion of the central retaining rod comprises a stop element and/or a mark to provide the user with a visual reference so as to identify whether the central retaining rod is in the locking or unlocking position.

4. A laundry drier as claimed in claim 1, wherein the central retaining rod is axially displaceable via a clockwise or anticlockwise rotation of the rod.

5. A laundry drier as claimed in claim 1, wherein the central retaining rod is provided with a threaded central section which is partially screwed into a central through hole of a hollow element.

6. A laundry drier as claimed in claim 5, wherein the central hollow element is attached to the supporting wall of the casing.

7. A laundry drier as claimed in claim 5, wherein the central retaining rod is axially displaceable via a clockwise or anticlockwise rotation of the rod into the central hollow element.

8. A laundry drier as claimed in claim 1, wherein the elastically-deformable hollow body comprises elastomeric material.

9. A laundry drier as claimed in claim 5, wherein the central hollow element comprises metal material.

10. A laundry drier as claimed in claim 5, wherein the central hollow element is selected from the group consisting of a stud, a buckle and a bushing.

11. A laundry drier as claimed in claim 10, wherein said central hollow element is force-fitted into the supporting wall of the casing.

12. A laundry drier as claimed in claim 1, wherein the refrigerant compressing device has a number of outwardly-projecting supporting legs, and the distal end of each supporting leg is firmly connected to the supporting wall of the casing via a respective vibration damper.

13. A laundry drier as claimed in claim 12, wherein the distal end of at least one supporting leg is provided with a through hole and the periphery of the elastically-deformable hollow body is firmly and rigidly fitted into the through hole of said supporting leg, adjacent an upper rim of the elastically-deformable hollow body and spaced from central hollow element.

14. A laundry drier as claimed in claim 1, wherein the supporting wall of the casing is a bottom wall of the casing.

15. A laundry drier comprising an outer casing and, inside the casing, a laundry drying container for housing the laundry to be dried, and a hot-air generator for circulating a stream of hot air inside the laundry drying container; said hot-air generator being provided with a heat-pump assembly having a refrigerant compressing device which is connected to a supporting wall of the casing via one or more vibration dampers structured for floatingly supporting the refrigerant compressing device, wherein:
at least one of said vibration dampers comprises an elastically-deformable body in abutment against the supporting wall of the casing, and a retaining member,
the retaining member being displaceable between a locking position in which the retaining member compresses said elastically-deformable body so as to rigidly connect the compressing device to the supporting wall of the casing and an unlocking position in which said elastically-deformable body floatingly supports the refrigerant compressing device, and
a portion of the retaining member being accessible from outside of the outer casing so as to allow a user to displace the retaining member to move it between said locking position and said unlocking position.

16. A laundry drier as claimed in claim 15, wherein an end portion of the retaining member protrudes from the supporting wall outside of the casing.

17. A laundry drier as claimed claim 16, wherein the end portion of the retaining member comprises a stop element and/or a mark to provide the user with a visual reference so as to identify whether the retaining member is in the locking or unlocking position.

18. A laundry drier as claimed in claim 15, wherein the retaining member is axially displaceable via a clockwise or anticlockwise rotation of the retaining member.

19. A laundry drier as claimed in claim 15, wherein the retaining member is provided with a threaded section which is partially screwed into a through hole extending through the supporting wall of the casing.

20. A laundry drier as claimed in claim 15, wherein the elastically-deformable body is a hollow body made of elastomeric material.

21. A laundry drier comprising an outer casing and, inside the casing, a laundry drying container for housing the laundry to be dried, and a hot-air generator for circulating a stream of hot air inside the laundry drying container; said hot-air generator being provided with an operative device which is connected to a supporting wall of the casing via one or more vibration dampers structured for floatingly supporting the device, wherein:
at least one of said vibration dampers comprises an elastically-deformable body in abutment against the supporting wall of the casing, and a retaining member,
the retaining member being displaceable between a locking position in which the retaining member compresses said elastically-deformable body so as to rigidly connect the device to the supporting wall of the casing and an unlocking position in which said elastically-deformable body floatingly supports the device, and
a portion of the retaining member being accessible from outside of the outer casing so as to allow a user to displace the retaining member to move it between said locking position and said unlocking position.
